(19) United States
(12) Patent Application Publication
(10) Pub. No.: US 2019/0072869 A1
(43) Pub. Date: Mar. 7, 2019

(54) ELECTROSTATIC IMAGE-DEVELOPING TONER EXTERNAL ADDITIVE, METHOD FOR PRODUCING THE SAME, AND TONER

(71) Applicant: SHIN-ETSU CHEMICAL CO., LTD., Tokyo (JP)

(72) Inventors: Kazuyuki MATSUMURA, Takasaki-shi (JP); Masanobu NISHIMINE, Takasaki-shi (JP); Tomoya OGATA, Annaka-shi (JP); Yoshiteru SAKATSUME, Sakura-shi (JP)

(73) Assignee: SHIN-ETSU CHEMICAL CO., LTD., Tokyo (JP)

(21) Appl. No.: 16/106,856

(22) Filed: Aug. 21, 2018

(30) Foreign Application Priority Data
Sep. 4, 2017 (JP) 2017-169818

(51) Int. Cl. G03G 9/097

(52) U.S. Cl. CPC G03G 9/09725; G03G 9/09716

(57) ABSTRACT

The invention provides: an electrostatic image-developing toner external additive including granulated silica which is a granulated material of silica powders each having a primary particle size of 5 to 50 nm and a degree of hydrophobization of 50% or more, the granulated silica having a loose bulk density of 150 g/L or more; and a toner including the electrostatic image-developing toner external additive. These provide an electrostatic image-developing toner external additive excellent in handleability and workability and also capable of improving image quality, and a toner using the external additive.

### BACKGROUND OF THE INVENTION

### Field of the Invention

The present invention relates to an electrostatic image-developing toner external additive used to develop an electrostatic image in an electrophotographic method, electrostatic recording method, and so forth; a method for producing the external additive; and a toner using the external additive.

### Description of the Related Art

Silica powders that are fine particles having a primary particle size of about several tens nm, are ordinarily manufactured by a process referred to as a wet method or a dry method. The wet silica is obtained by the reaction of sodium silicate and sulfuric acid to form silica precipitate, followed by filtration, drying, grinding, and classification thereof. On the other hand, the dry silica is obtained by subjecting tetrachlorosilane to high-temperature hydrolysis by an oxyhydrogen flame in a vapor phase.

Recently, toners for developing electrostatic images used in digital copiers and laser printers are mixed with silica powders as an external additive to improve fluidity of the toners, prevent adhesion among the toner particles, and improve the image quality, for example. Since silica powders exhibit hydrophilicity due to the presence of silanol groups on the surfaces, silica powders, if unmodified, change the charge amount of the toners depending on humidity, and cause image quality deterioration. To prevent these, it has been proposed that silica powders called fumed silica, one type of the dry silica, obtained by subjecting a silicon halide to vapor-phase high-temperature thermal decomposition are hydrophobized with surface treatment agents such as a silane coupling agent and silicone oil, and used as a toner external additive (see Patent Literatures 1, 2).

These silica powders are characterized by having white color and large specific surface areas, and widely used as various additives, particularly an agent for improving fluidity of toners. In the actual use thereof, however, the smaller bulk density and easiness of scattering cause problems, for example, that a larger container is necessary for storing and the workability is also poor.

Meanwhile, Patent Literatures 3, 4 have proposed methods in which, as a toner external additive, colloidal silica or alumina powders having an average primary particle size of 5 to 100 nm are granulated using synthetic resins or rubbers. Certainly, the methods can increase the bulk density and improve the workability and so forth. However, these toner external additives are hardly disintegrated when toners are formed, and also have such problems that the fluidity is not exhibited quickly. Further, as recently-used toners have smaller particle sizes from 10 μm to 7 μm, there is a problem that the fluidity of the toners is decreased. For the improvement, toner external additives are added in larger amounts than those of conventional toner external additives. Nevertheless, the toner external additives consequently give a great impact on the chargeability of the toners. Particularly, the charge variation due to the environment is now problematic. To prevent these, toner external additives highly hydrophobic and excellent in fluidity have been desired.

### PRIOR ART DOCUMENTS

### Patent Literatures

Patent Literature 1: Japanese Unexamined Patent Publication (Kokai) No. Sho 59-231550
Patent Literature 2: Japanese Unexamined Patent Publication (Kokai) No. Sho 63-73272
Patent Literature 3: Japanese Examined Patent Publication (Kokoku) No. Hei 1-19143
Patent Literature 4: Japanese Unexamined Patent Publication (Kokai) No. Sho 58-79260

### SUMMARY OF THE INVENTION

The present invention was accomplished to solve the above problems. An object of the present invention is to provide: an electrostatic image-developing toner external additive excellent in handleability and workability and also capable of improving image quality; a method for producing the external additive; and a toner using the external additive.

To solve the foregoing problems, the present invention provides an electrostatic image-developing toner external additive comprising granulated silica which is a granulated material of silica powders each having

a primary particle size of 5 to 50 nm and

a degree of hydrophobization of 50% or more, wherein the granulated silica has a loose bulk density of 150 g/L or more.

The electrostatic image-developing toner external additive like this is formed from granulated silica that is excellent in handleability and workability, has favorable dispersibility to a toner from the production and is effective in improving the image quality.

The silica powders are preferably powders of wet silica or dry silica.

These silica powders are favorable for the electrostatic image-developing toner external additive of the present invention.

The present invention further provides a method for producing the electrostatic image-developing toner external additive, comprising:

a granulation step of granulating silica powders each having a primary particle size of 5 to 50 nm by use of a solvent; and

hydrophobizing each surface of the silica powders with a silicon atom-containing hydrophobizing agent before or simultaneously with the granulation step to form the granulated silica.

The production method like this enables silica powders to have hydrophobized surface securely, making it possible to produce the inventive electrostatic image-developing toner external additive easily and at low cost.

It is preferable that the silicon atom-containing hydrophobizing agent be at least one member selected from organosilazane compounds, polysilazane compounds, organosilane compounds, and organopolysiloxanes.

The silicon atom-containing hydrophobizing agent like this enables silica powders to have hydrophobized surface more securely, and is particularly favorable for the method for producing an electrostatic image-developing toner external additive of the present invention.

The solvent used in the granulation step is preferably an alcohol, water or both.

The solvent like this is easy to handle and can reduce the cost in selecting devices and treating the granulated materials.

Furthermore, the present invention provides a toner comprising the above-described electrostatic image-developing toner external additive.

The toner like this has favorable fluidity and electrostatic property and is capable of improving image quality.

As has been described above, the inventive electrostatic image-developing toner external additive is excellent in handleability, workability, and storability of the toner external additive itself, and is capable of quickly imparting fluidity to a toner or a developer, imparting favorable chargeability, and improving image quality. Additionally, the inventive method for producing an electrostatic image-developing toner external additive makes it possible to produce such an electrostatic image-developing toner external additive easily and at low cost.

### DETAILED DESCRIPTION OF THE PREFERRED EMBODIMENTS

As described above, it has been desired to develop an electrostatic image-developing toner external additive excellent in handleability and workability and also capable of improving image quality, and a toner using the external additive.

The present inventors have diligently studied the foregoing problems to accomplish and consequently found that silica powders which have a prescribed degree of hydrophobization and loose bulk density, with the surface being hydrophobized with a silicon atom-containing hydrophobizing agent before or simultaneously with the granulation step in solvent granulation of silica powders having primary particle sizes of 5 to 50 nm, makes it possible to improve the handleability, and also improve the dispersibility to a toner and the fluidity of the toner; thereby brought the present invention to completion.

That is, the present invention is an electrostatic image-developing toner external additive comprising granulated silica which is a granulated material of silica powders each having

a primary particle size of 5 to 50 nm and

a degree of hydrophobization of 50% or more, wherein the granulated silica has a loose bulk density of 150 g/L or more.

Hereinafter, the present invention will be described in detail, but the present invention is not limited thereto.

### <Electrostatic Image-Developing Toner External Additive>

The electrostatic image-developing toner external additive of the present invention is formed of granulated silica which is a granulated material of silica powders each having a primary particle size of 5 to 50 nm and a degree of hydrophobization of 50% or more, the granulated silica having a loose bulk density of 150 g/L or more.

The silica powder before granulation, which is a raw material for the granulated silica, has a primary particle size of 5 to 50 nm. The silica powder with the primary particle size before granulation being less than 5 nm is not manufactured in large quantities, and is not suitable for practical use. Meanwhile, the silica powder with the primary particle size before granulation being more than 50 nm is not preferable because the primary particle size is too large and the bulk density is also originally so large that the granulation is meaningless. The silica powder before granulation preferably has a primary particle size of 5 to 50 nm and a loose bulk density of less than 150 g/L, and particularly preferably has a primary particle size of 5 to 20 nm and a loose bulk density of 20 to 100 g/L. When the silica powder before granulation has a primary particle size and a loose bulk density being in the above ranges, this improves the workability in forming the electrostatic image-developing toner external additive from the granulated silica, and makes the fluidity excellent when granules are disintegrated. Incidentally, the primary particle size in the present invention refers to a diameter of the particle measured under a transmission electron microscope.

The silica powder before granulation may be any of hydrophilic silica, and is preferably a powder of wet silica or dry silica. The wet silica can be manufactured by a precipitation method or a gelation method, for example, and the wet silica manufactured by a precipitation method is preferable since it is easy to be dispersed by shearing due to the bond of secondary particles is soft compared to the one manufactured by a gelation method. Illustrative example of the dry silica includes dry silica manufactured by high-temperature hydrolysis of tetrachlorosilane.

In the granulated silica, the silica powder has a degree of hydrophobization of 50% or more and a loose bulk density of 150 g/L or more. The granulated silica having such a degree of hydrophobization and loose bulk density can be obtained, as will be described later in detail, by granulating the raw-material silica powders by use of a solvent, and hydrophobizing each surface of the silica powders with a silicon atom-containing hydrophobizing agent before or simultaneously with the granulation step. When the silica powders have a degree of hydrophobization of less than 50%, the insufficient hydrophobization causes agglomeration of the silica, and if the resulting granulated silica is added as an electrostatic image-developing toner external additive to a toner, the charge amount or charge variation due to an environmental difference is likely to change or occur. Meanwhile, when the granulated silica has a loose bulk density less than 150 g/L, the granulation is insufficient, thereby making the handleability worse. Incidentally, the degree of hydrophobization and the loose bulk density in the present invention refer to the ones measured under the following conditions.

### <Method for Measuring Degree of Hydrophobization (Methanol Titrimetric Method)>

A 200 mL beaker is charged with 50 mL of pure water, 0.2 g of a sample is added thereto, and the contents are stirred with a magnet stirrer. With the distal end of a buret filled with methanol being introduced in the liquid and with stirring, methanol is added dropwise to measure the amount of added methanol to disperse the sample into the water completely. The degree of hydrophobization is obtained according to the following equation when the amount of added methanol is expressed as Y mL:

the degree of hydrophobization (%)={Y/(50+Y)}×100

### <Method for Measuring Loose Bulk Density>

The tester used is Multi Tester MT-1000 manufactured by SEISHIN ENTERPRISE CO., LTD. At the top of the feeder unit, a funnel, a sieve (opening diameter: 150 μm), and a spacer for the sieve are stacked in this order and are fixed with a stopper. On the sample stand, a 100 mL cell is set. With a sample being introduced into the sample unit, the feeder is vibrated whereby the sample falls down from the sieve to fill up the cell. The sample fill is leveled off with a leveling blade. The loose bulk density ρ (g/L) is obtained by the following equation:

ρ={(W1−W0)/100}×1000

wherein W0 represents the weight of the cell container (g), and W1 represents the weight of the cell container and the sample (g).

As described above, the inventive electrostatic image-developing toner external additive formed from the above-described granulated silica is excellent in handleability, and quickly disintegrated when added to a toner, so that the dispersibility is also excellent. This makes it possible to impart favorable fluidity to a toner. Moreover, since the inventive electrostatic image-developing toner external additive is favorably hydrophobized, too, it is capable of imparting favorable chargeability to a toner.

### <Toner>

The present invention also provides a toner including the above-described electrostatic image-developing toner external additive. In the inventive toner, the electrostatic image-developing toner external additive is externally added to toner particles which may be known toner particles mainly containing a binder resin and a colorant.

Since the inventive electrostatic image-developing toner external additive is added, the inventive toner has favorable fluidity and electrostatic property and is capable of improving image quality.

### <Method for Producing Electrostatic Image-Developing Toner External Additive>

The present invention also provides a method for producing an electrostatic image-developing toner external additive, comprising:

a granulation step of granulating silica powders each having a primary particle size of 5 to 50 nm by use of a solvent; and

hydrophobizing each surface of the silica powders with a silicon atom-containing hydrophobizing agent before or simultaneously with the granulation step to form the granulated silica.

Usually, in a production method in which silica powders agglomerate with a solvent such as water or an alcohol, the agglomeration is so facilitated that the granules are hardly disintegrated. Nevertheless, alcohols and water are media easy to handle for granulation and drying in an industrial level which effect to the cost in selecting devices and treating the granulated materials.

Accordingly, in the inventive method for producing an electrostatic image-developing toner external additive, the surface of silica powder is hydrophobized with a silicon atom-containing hydrophobizing agent, thereby allowing the silica powders to be granulated by using a solvent while preventing the silica powders from excess aggregation due to the solvent. Thus, the granulated silica is formed as the electrostatic image-developing toner external additive. This makes it possible to produce an electrostatic image-developing toner external additive that is excellent in handleability and disintegration and capable of imparting favorable fluidity to a toner easily and at low cost.

Incidentally, the silica powder having a primary particle size of 5 to 50 nm, which is a raw material of the granulated silica may include ones that are enumerated in the explanation of the electrostatic image-developing toner external additive described above.

As the silicon atom-containing hydrophobizing agent to hydrophobize the surface of silica powder, it is preferable to use at least one member selected from organosilazane compounds, polysilazane compounds, organosilane compounds, and organopolysiloxanes. As the silicon atom-containing hydrophobizing agent like this, any known one can be used including, for example, organosilazane compounds such as hexamethyldisilazane, diphenyltetramethyldisilazane, and divinyltetramethyldisilazane; polysilazane compounds such as perhydropolysilazane and methylhydropolysilazane; organosilane compounds such as organoalkoxysilanes, organochlorosilanes and partial hydrolysis products of them, for example, organoalkoxysilanes such as methyltrimethoxysilane, methyltriethoxysilane, phenyltrimethoxysilane, dimethyldimethoxysilane, vinyltrimethoxysilane, vinyltriethoxysilane, divinyldimethoxysilane, vinylmethyldimethoxysilane, and vinyltris(methoxyethoxy)silane; organochlorosilanes such as methyltrichlorosilane, phenyltrichlorosilane, and vinyltrichlorosilane; and organopolysiloxanes such as a siloxane oligomer with the polymerization degree of 50 or less having a functional group including an Si—OH group or an Si—OR′ group (R′ represents a monovalent hydrocarbon group) at the terminal of the molecular chain.

The solvent used is preferably alcohols and water. The alcohols are preferably methanol, ethanol, isopropyl alcohol, and the like. Particularly, methanol and water is preferable from the viewpoints of cost, safety, and so forth. Both of alcohols and water can be used together.

In the granulation step of granulating silica powders with a solvent, an agitating granulator is preferably used. Illustrative examples of the usable agitating granulator include batch apparatuses such as a Henschel mixer, EIRICH mixer, and a high-speed mixer; and continuous apparatuses such as a horizontal axis blade. With these apparatuses, it is possible to disperse a solvent to silica powders uniformly by supplying the solvent with a spray while the silica powders are stirred and mixed at high speed to give granulated silica in an appropriate ratio of the silica powders and the solvent, together with appropriate stirring intensity and stirring time.

In the inventive method for producing an electrostatic image-developing toner external additive, the surface of silica powder is hydrophobized with a silicon atom-containing hydrophobizing agent before or simultaneously with the granulation step.

When the surface of silica powder is hydrophobized before the granulation step, the surface of silica powder can be hydrophobized by previously mixing the silica powders and a silicon atom-containing hydrophobizing agent by an appropriate method before introducing the silica powders into a granulation apparatus such as the agitation granulator. The solvent granulation can be performed after hydrophobizing the surface of silica powder by introducing the silica powders into a granulation apparatus, followed by spraying a silicon atom-containing hydrophobizing agent with a spray of the granulation apparatus.

When the surface of silica powder is hydrophobized simultaneously with the granulation step, it is possible to perform hydrophobizing of the surface of silica powder and granulation simultaneously by introducing the silica powders into a granulation apparatus such as the agitation granulator, followed by spraying a mixture of a silicon atom-containing hydrophobizing agent and a solvent with a spray of the granulation apparatus.

The method for preparing the mixture of a hydrophobizing agent and a solvent used at this stage can be appropriately selected in accordance with the kind of the hydrophobizing agent. When the hydrophobizing agent has favorable compatibility with the solvent, it can be mixed by simple mixing. When the hydrophobizing agent has poor compatibility with the solvent, it can be dispersed homogeneously with a mixing apparatus such as a homogenizer to prepare the mixture. As a method other than the mechanical homogenization, for example, when water is used as the solvent, the hydrophobizing agent and water can be mixed by adding appropriate amount of organic solvent such as alcohols to make the hydrophobizing agent and water compatible.

The appropriate ratio of silica powders and a solvent for obtaining the granulated silica can be appropriately selected in accordance with the kind and amount of the hydrophobizing agent. The weight ratio of the solvent to the silica powders is preferably set to 0.1 to 5, particularly preferably 0.5 to 3, of the solvent with respect to 1 of the silica powders.

The inventive method for producing an electrostatic image-developing toner external additive preferably has a drying step of removing the solvent used for the granulating subsequent to the granulation step. Illustrative examples of the apparatus used for the drying step include a continuous hot-air dryer, a batch type dryer, a material transfer dryer, a material agitation dryer, a hot air transfer dryer, and a vacuum dryer. Any dryer may be used, but excess force applied at the stage with higher water content or solvent content has a risk of causing pasting of the granulated silica. Even when pasting is not caused, there occurs a risk of causing coarse grains. Accordingly, it is preferable to select a mechanism by which excess force is not applied to the granulated silica. In the drying step, the granulated silica contains a hydrophobizing agent, and is preferably dried under a condition of lacking oxygen, specifically in an inert atmosphere such as nitrogen in order to prevent decomposition of the hydrophobizing agent. However, it is also possible to use hot air to remove the solvent for drying at a relatively lower temperature in view of economical reasons.

The drying step is preferably followed by a heat treatment step of heating the granulated silica at a temperature of 150 to 300° C. As an apparatus used in the heat treatment step, it is possible to use the same apparatus used in the drying step. The heat treatment is performed at a temperature of 150 to 300° C., the reaction time of which is required to be about 4 hours at most, and accordingly it is preferable to perform the heat treatment under a condition of lacking oxygen, specifically in an inert atmosphere such as nitrogen in order to prevent decomposition of the hydrophobizing agent.

As described above, the inventive method for producing an electrostatic image-developing toner external additive makes it possible to produce an electrostatic image-developing toner external additive that is excellent in handleability and workability, has favorable dispersibility to a toner, and is capable of improving fluidity of a toner and imparting favorable electrostatic property easily and at low cost.

### EXAMPLES

Hereinafter, the present invention will be described specifically by showing Examples and Comparative Examples, but the present invention is not limited thereto. Incidentally, the average polymerization degree in Examples means a weight average molecular weight measured by gel permeation chromatography (GPC) in terms of polystyrene.

### <Method for Measuring Loose Bulk Density>

The tester used was Multi Tester MT-1000 manufactured by SEISHIN ENTERPRISE CO., LTD. At the top of the feeder unit, a funnel, a sieve (opening diameter: 150 μm), and a spacer for the sieve were stacked in this order and were fixed with a stopper. On the sample stand, a 100 mL cell was set. With a sample being introduced into the sample unit, the feeder was vibrated, whereby the sample fell down from the sieve to fill up the cell. The sample fill was leveled off with a leveling blade. The loose bulk density ρ (g/L) is obtained by the following equation:

ρ={(W1−W0)/100}×1000

wherein W0 represents the weight of the cell container (g), and W1 represents the weight of the cell container and the sample (g).

### <Method for Measuring Degree of Hydrophobization (Methanol Titrimetric Method)>

A 200 mL beaker was charged with 50 mL of pure water, 0.2 g of a sample was added thereto, and the contents were stirred with a magnet stirrer. With the distal end of a buret filled with methanol being introduced in the liquid and with stirring, methanol was added dropwise to measure the amount of added methanol to disperse the sample into the water completely. The degree of hydrophobization is obtained according to the following equation when the amount of added methanol is expressed as Y mL:

the degree of hydrophobization (%)={Y/(50+Y)}×100

(Production of Toner External Additive Formed from Granulated Silica)

### Example 1

The following procedure was performed on fumed silica with the BET specific surface area of 200 m²/g, the primary particle size of 10 nm, and the loose bulk density of 45 g/L obtained by high-temperature hydrolysis of silane. A high-speed mixer (capacity: 10 L) was charged with 200 g of the fumed silica, and was operated at a rotation rate of 1,500 rpm. After the rotation had become stable, a mixture of 550 g of methanol and 0.5 g of hexamethyldisilazane with 25 g of a short-chain siloxane obtained from a hydrolysis product of dimethyldimethoxysilane from which water and methanol had been removed was sprayed for 2 minutes as a hydrophobizing agent. The obtained wet granulated material had a loose bulk density of 352 g/L. Then, the obtained wet granulated material was dried to remove the methanol in a dryer to give dried granulated material having a loose bulk density of 210 g/L. Subsequently, 100 g of this dried granulated material was charged into a 2 L flask, and heated at 250° C. for 2.5 hours. A toner external additive formed from the obtained granulated silica had a loose bulk density of 197 g/L and a degree of hydrophobization of 60% according to the methanol titrimetric method.

### Example 2

The following procedure was performed on fumed silica with the BET specific surface area of 200 m²/g, the primary particle size of 10 nm, and the loose bulk density of 45 g/L obtained by high-temperature hydrolysis of silane. A high-speed mixer (capacity: 10 L) was charged with 200 g of the fumed silica, and was operated at a rotation rate of 1,500 rpm. After the rotation had become stable, 75 g of a short-chain siloxane obtained from a hydrolysis product of dimethyldimethoxysilane from which water and methanol had been removed was sprayed for 20 seconds as a hydrophobizing agent, followed by spraying 300 g of pure water for 60 seconds. The obtained wet granulated material had a loose bulk density of 362 g/L. Then, the obtained wet granulated material was dried to remove the water in a dryer to give dried granulated material having a loose bulk density 198 g/L. Subsequently, 100 g of this dried granulated material was charged into a 2 L flask, and heated at 250° C. for 2.5 hours. A toner external additive formed from the obtained granulated silica had a loose bulk density of 186 g/L and a degree of hydrophobization of 55% according to the methanol titrimetric method.

### Example 3

The following procedure was performed on fumed silica with the BET specific surface area of 200 m²/g, the primary particle size of 10 nm, and the loose bulk density of 45 g/L obtained by high-temperature hydrolysis of silane. A high-speed mixer (capacity: 10 L) was charged with 200 g of the fumed silica, and was operated at a rotation rate of 1,500 rpm. After the rotation had become stable, 12 g of pure water was sprayed for 10 seconds. Thereafter, a mixture of 450 g of methanol and 32 g of hexamethyldisilazane was sprayed for 2 minutes as a hydrophobizing agent. The obtained wet granulated material had a loose bulk density of 364 g/L. Then, the obtained wet granulated material was dried to remove the methanol and water in a dryer to give dried granulated material having a loose bulk density of 220 g/L. Subsequently, 100 g of this dried granulated material was charged into a 2 L flask, and heated at 250° C. for 2.5 hours. A toner external additive formed from the obtained granulated silica had a loose bulk density of 202 g/L and a degree of hydrophobization of 58% according to the methanol titrimetric method.

### Example 4

The same procedure as in Example 2 was performed on fumed silica with the BET specific surface area of 45 m²/g, the primary particle size of 50 nm, and the loose bulk density of 50 g/L obtained by high-temperature hydrolysis of silane. The obtained wet granulated material had a loose bulk density of 450 g/L. Then, the obtained wet granulated material was dried to remove the water in a dryer to give dried granulated material having a loose bulk density of 280 g/L. Subsequently, 100 g of this dried granulated material was charged into a 2 L flask, and heated at 250° C. for 2.5 hours. A toner external additive formed from the obtained granulated silica had a loose bulk density of 260 g/L and a degree of hydrophobization of 52% according to the methanol titrimetric method.

### Example 5

The same procedure as in Example 2 was performed on wet silica with the primary particle size of 20 nm and the loose bulk density of 126 g/L obtained by a wet precipitation method. The obtained wet granulated material had a loose bulk density of 416 g/L. Then, the obtained wet granulated material was dried to remove the water in a dryer to give dried granulated material having a loose bulk density of 203 g/L. Subsequently, 100 g of this dried granulated material was charged into a 2 L flask, and heated at 250° C. for 2.5 hours. A toner external additive formed from the obtained granulated silica had a loose bulk density of 200 g/L, and a degree of hydrophobization of 57% according to the methanol titrimetric method.

### Example 6

A high-speed mixer (capacity: 10 L) was charged with 200 g of the same fumed silica as in Example 2, and was operated at a rotation rate of 1,500 rpm. After the rotation had become stable, 25 g of linear dimethylsiloxane oligomer the terminal of which was blocked by a silanol group (polymerization degree: about 30) was sprayed for 10 seconds as a hydrophobizing agent, followed by spraying 300 g of pure water for 60 seconds. Then, this was subjected to drying and heating under the same conditions as in Example 2. A toner external additive formed from the obtained granulated silica had a loose bulk density of 190 g/L and a degree of hydrophobization of 65% according to the methanol titrimetric method.

### Comparative Example 1

A high-speed mixer (capacity: 10 L) was charged with 200 g of the same fumed silica as in Example 1, and was operated at a rotation rate of 1,500 rpm. After the rotation had become stable, 570 g of methanol was sprayed for 2 minutes without spraying a hydrophobizing agent. The obtained wet granulated material had a loose bulk density of 410 g/L. Then, the obtained wet granulated material was dried to remove the methanol in a dryer to give dried granulated material (toner external additive formed from Comparative granulate silica) having a loose bulk density of 190 g/L. The toner external additive formed from this Comparative granulate silica was not hydrophobized, and was dispersed in water (i.e., the degree of hydrophobization was 0%).

### Comparative Example 2

To 170 ml of a 2 mass % MEK solution containing a mixture of 60 parts by mass of styrene resin particles (SX-500H manufactured by Soken Chemical & Engineering Co., Ltd.) and 40 parts by mass of acrylic resin particles (MX-500H manufactured by Soken Chemical & Engineering Co., Ltd.), 100 g of hydrophobic colloidal silica (RY-200 manufactured by NIPPON AEROSIL CO., LTD. with the BET specific surface area of 200 m²/g, the primary particle size of 12 nm, and the loose bulk density of 60 g/L) was added and stirred. Then, the resulting gel-like material was introduced into a vat and air-dried. Next, after the air-drying, the material was ground in a mortar. A toner external additive formed from the obtained granulated silica had a loose bulk density of 310 g/L and a degree of hydrophobization of 47% according to the methanol titrimetric method.

### Comparative Example 3

To 100 ml of a 1 mass % toluene solution containing a cyclized rubber (Alpex CK450 manufactured by Hoechst), 100 g of hydrophobic colloidal silica (RY-200 manufactured by NIPPON AEROSIL CO., LTD. with the BET specific surface area of 200 m²/g, the primary particle size of 12 nm, and the loose bulk density of 60 g/L) was added and stirred. Then, the resulting gel-like material was introduced into a vat and air-dried at 50° C. Next, after the air-drying, the material was ground in a mortar. A toner external additive formed from the obtained granulated silica had a loose bulk density of 356 g/L and a degree of hydrophobization of 49% according to the methanol titrimetric method.

### Comparative Example 4

Hydrophobic colloidal silica (RY-200 manufactured by NIPPON AEROSIL CO., LTD. with the BET specific surface area of 200 m²/g, the primary particle size of 12 nm, and the loose bulk density of 60 g/L) was directly used as a toner external additive.

Table 1 shows the property results of the toner external additives of Examples 1 to 6 and Comparative Examples 1 to 4.

The toner external additives of Examples 1 to 6 and Comparative Examples 1 to 4 were used to produce toners which were subjected to various measurements according to the following methods.

### [Preparation of External Additive-Mixed Toner]

96 parts by mass of a polyester resin with the glass transition temperature (Tg) of 60° C. and the softening point of 110° C. and 4 parts by mass of a colorant (product name: Carmine 6BC, manufactured by Sumitomo Color Co., Ltd.) were melted and kneaded together, and then crushed and classified to obtain toner particles having an average particle size of 7 μm. With 10 g of the toner particles, 0.3 g of one of the toner external additives of Examples 1 to 6 and Comparative Examples 1 to 4 was mixed in a sample mill. Thus, external additive-mixed toners were obtained. Using these, the aggregation degrees were evaluated by the following method.

### [Aggregation Degree]

The aggregation degree is a value indicating the fluidity of powder. This aggregation degree was measured using a powder tester (manufactured by HOSOKAWA MICRON CORPORATION) and three stage sieves of 200-, 100-, and 60-mesh sieves which were stacked in this order from the bottom. As the measurement means, 5 g of a toner powder is put on the uppermost 60-mesh sieve of the three stage sieves, and a voltage of 2.5 V is applied to the powder tester to vibrate the three stage sieves for 15 seconds. Thus, the aggregation degree (%) is calculated according to the following equation from the mass a (g) of the powder remaining on the 60-mesh sieve, the mass b (g) of the powder remaining on the 100-mesh sieve, and the mass c (g) of the powder remaining on the 200-mesh sieve.

the aggregation degree (%)=(a+b×0.6+c×0.2)×100/5

It can be evaluated that the smaller the aggregation degree, the better the fluidity, while the larger the aggregation degree, the worse the fluidity. Table 2 shows these results.

### [Preparation of Developer]

Developers were prepared by mixing 3 parts of one of the external additive-mixed toners with 97 parts of ferrite (product name: FL-80, manufactured by Powdertech Co., Ltd.) as a carrier. Using these developers, the toner charge amounts and the adhesions of the toners to a photoreceptor were evaluated by the following methods.

### [Toner Charge Amount]

The developers were adjusted in terms of moisture and mixed in accordance with the toner charge amount measurement criteria (Journal of the Imaging Society of Japan, 37, 461 (1998)) of the Standard of the Imaging Society of Japan. The toner charge amounts were measured at various mixing periods. Incidentally, a paint conditioner (manufactured by Toyo Seiki Seisaku-sho, Ltd.) was used for the mixing, and a blow-off charge amount measuring apparatus (manufactured by Toshiba Chemical Corporation, product name: TB203) was used for measuring the toner charge amounts. The moisture adjustment and the measurement were performed at a temperature of 23±3° C. and a humidity of 55±10%. Table 2 shows these results.

### [Printing Property]

Further, 100 parts by mass of a polyester resin for toner, 4 parts by mass of carbon black, and 3 parts by mass of an ester-based wax were melted and kneaded together, and then crushed and classified. Then, to 100 parts by mass of the toner particles thus adjusted to 7.2 μm, 0.5 parts by mass of one of the toner external additives of Examples 1 to 6 and Comparative Examples 1 to 4 was externally added to thus prepare electrostatic image-developing toners. Each of these toners was charged into an IPSIO SP6110 printer manufactured by Ricoh Co., Ltd. After 30000 sheets were printed, the properties were observed. Image quality and contamination inside the printer due to the scattering of the toners were observed. Table 3 shows the results.

TABLE 1

| | Primary | Degree of | |
|---|---|---|---|
| | particle | hydrophobization | Loose bulk |
| | size (nm) | (%) | density (g/L) |
| Example 1 | 10 | 60 | 197 |
| Example 2 | 10 | 55 | 186 |
| Example 3 | 10 | 58 | 202 |
| Example 4 | 50 | 52 | 260 |
| Example 5 | 20 | 57 | 200 |
| Example 6 | 10 | 65 | 190 |
| Comparative | 10 | 0 | 190 |
| Example 1 | | | |
| Comparative | 12 | 47 | 310 |
| Example 2 | | | |
| Comparative | 12 | 49 | 356 |
| Example 3 | | | |
| Comparative | 12 | 75 | 60 |
| Example 4 | | | |

TABLE 2

| | | | | | | | | Comparative | | | |
|---|---|---|---|---|---|---|---|---|---|---|---|
| | | Example | | | | | | Example | | | |
| | | 1 | 2 | 3 | 4 | 5 | 6 | 1 | 2 | 3 | 4 |
| Toner | | 2 | 3 | 2 | 4 | 4 | 3 | 72 | 89 | 90 | 4 |
| aggregation | | | | | | | | | | | |
| degree | | | | | | | | | | | |
| Blow-off | Value | −42 | −39 | −38 | −35 | −36 | −43 | −24 | −15 | −12 | −40 |
| charge | after 4- | | | | | | | | | | |
| amount | minute | | | | | | | | | | |
| | mixing | | | | | | | | | | |
| | (μC/g) | | | | | | | | | | |
| | Value | −40 | −38 | −37 | −34 | −35 | −40 | −22 | −16 | −10 | −39 |
| | after16- | | | | | | | | | | |
| | minute | | | | | | | | | | |
| | mixing | | | | | | | | | | |
| | (μC/g) | | | | | | | | | | |
| | Value | −35 | −34 | −31 | −33 | −32 | −37 | −18 | −17 | −8 | −32 |
| | after 32- | | | | | | | | | | |
| | minute | | | | | | | | | | |
| | mixing | | | | | | | | | | |
| | (μC/g) | | | | | | | | | | |

TABLE 3

| | Example | | | | | | Comparative Example | | | |
|---|---|---|---|---|---|---|---|---|---|---|
| | 1 | 2 | 3 | 4 | 5 | 6 | 1 | 2 | 3 | 4 |
| Image | same as | same as | same as | same as | same as | same as | worse | worse | worse | same as |
| quality | initial | initial | initial | initial | initial | initial | | | | initial |
| after | image | image | image | image | image | image | | | | image |
| 30000- | quality | quality | quality | quality | quality | quality | | | | quality |
| sheet | | | | | | | | | | |
| printing | | | | | | | | | | |
| Toner | none | none | none | none | none | none | scattered | scattered | scattered | none |
| scattering | | | | | | | | | | |
| after | | | | | | | | | | |
| 30000- | | | | | | | | | | |
| sheet | | | | | | | | | | |
| printing | | | | | | | | | | |

The above results revealed that the inventive electrostatic image-developing toner external additive is excellent in handleability, workability, and storability of the toner external additive itself, and is capable of quickly imparting fluidity to a toner or a developer, imparting favorable chargeability, and improving image quality (Examples 1 to 6).

On the other hand, in Comparative Examples 1 to 3 of the toner external additives having a degree of hydrophobization of not more than 50%, the fluidity was low, the toner charge amount and printing property were inferior. In addition, Comparative Example 4 in which the loose bulk density was less than 150 g/L with no granulation was performed was inferior in handleability.

It is to be noted that the present invention is not restricted to the foregoing embodiment. The embodiment is just an exemplification, and any examples that have substantially the same feature and demonstrate the same functions and effects as those in the technical concept described in claims of the present invention are included in the technical scope of the present invention.

1. An electrostatic image-developing toner external additive comprising granulated silica which is
a granulated material of silica powders each having
a primary particle size of 5 to 50 nm and
a degree of hydrophobization of 50% or more, wherein the granulated silica has a loose bulk density of 150 g/L or more.

2. The electrostatic image-developing toner external additive according to claim 1, wherein the silica powders are powders of wet silica or dry silica.

3. A method for producing the electrostatic image-developing toner external additive according to claim 1, the method comprising:
a granulation step of granulating silica powders each having a primary particle size of 5 to 50 nm by use of a solvent; and
hydrophobizing each surface of the silica powders with a silicon atom-containing hydrophobizing agent before or simultaneously with the granulation step to form the granulated silica.

4. A method for producing the electrostatic image-developing toner external additive according to claim 2, the method comprising:
a granulation step of granulating silica powders each having a primary particle size of 5 to 50 nm by use of a solvent; and
hydrophobizing each surface of the silica powders with a silicon atom-containing hydrophobizing agent before or simultaneously with the granulation step to form the granulated silica.

5. The method for producing the electrostatic image-developing toner external additive according to claim 3, wherein the silicon atom-containing hydrophobizing agent is at least one member selected from organosilazane compounds, polysilazane compounds, organosilane compounds, and organopolysiloxanes.

6. The method for producing the electrostatic image-developing toner external additive according to claim 4, wherein the silicon atom-containing hydrophobizing agent is at least one member selected from organosilazane compounds, polysilazane compounds, organosilane compounds, and organopolysiloxanes.

7. The method for producing the electrostatic image-developing toner external additive according to claim 3, wherein the solvent used in the granulation step is an alcohol, water or both.

8. The method for producing the electrostatic image-developing toner external additive according to claim 4, wherein the solvent used in the granulation step is an alcohol, water or both.

9. The method for producing the electrostatic image-developing toner external additive according to claim 5, wherein the solvent used in the granulation step is an alcohol, water or both.

10. The method for producing the electrostatic image-developing toner external additive according to claim 6, wherein the solvent used in the granulation step is an alcohol, water or both.

11. A toner comprising the electrostatic image-developing toner external additive according to claim 1.

12. A toner comprising the electrostatic image-developing toner external additive according to claim 2.
